(19) United States
(12) Patent Application Publication
(10) Pub. No.: US 2025/0065663 A1
(43) Pub. Date: Feb. 27, 2025

(54) UV-CURABLE INKJET INKS

(71) Applicant: Kornit Digital Ltd., Rosh HaAyin (IL)

(72) Inventors: Roi VIZEL, Tel-Aviv Yaffo (IL); Ira YUDOVIN-FARBER, Rehovot (IL); Mazi AMIEL-LEVY, Petach-Tikva (IL); Jacob MANN, Zoran (IL)

(73) Assignee: Kornit Digital Ltd., Rosh HaAyin (IL)

(21) Appl. No.: 18/724,615

(22) PCT Filed: Dec. 21, 2022
(86) PCT No.: PCT/IL2022/051367

§ 371 Date: Jun. 27, 2024

Related U.S. Application Data
(60) Provisional application No. 63/293,892, filed on Dec. 27, 2021.

(51) Int. Cl. B41M 7/00; C09D 11/322; C09D 11/54; D06P 5/30

(52) U.S. Cl. CPC B41M 7/0081; B41M 7/0018; C09D 11/322; C09D 11/54; D06P 5/30

(57) ABSTRACT

A process for digital printing on fabrics using cationic UV-curable ink compositions having acceptable wash-fastness and acceptable hand-feel.

### RELATED APPLICATIONS

This application claims the benefit of priority of U.S. Provisional Patent Application No. 63/293,892 filed on 27 Dec. 2021, the contents of which are incorporated herein by reference in their entirety.

### FIELD AND BACKGROUND OF THE INVENTION

The present invention, in some embodiments thereof, relates to textile printing, and more particularly, but not exclusively, to cationic UV-curable digital ink compositions and methods for using the same.

UV-curable inks formulated for inkjet printing technology provide some advantages for textile industry, such as more ecological use of materials, relative low levels of water consumption, waste, energy, and release of toxic chemicals compared to other textile coloring methodologies. UV-curable inks are generally divided into two families, radical and cationic. Cationic UV (ultraviolet)-curable inks and technology were developed in the early 1960s and initially focused on photo-resist applications. In the early '70s, as UV free radical use grew, cationic UV inks and coatings were developed commercially and used in converting plants. As the technology grew, UV free radical inks found application in offset printing applications for metal can decoration and in lithographic printing applications. UV technology was commercialized in the '70s to deal with volatile organic compound solvent emissions. With the downturn in the global economy, its superior productivity advantages have propelled its application in a variety of printing and converting processes. Demands for high print quality as well as the unique “feel” of UV-cured products continue to drive the UV inks and coatings markets.

Cationic UV ink technology lagged behind due to raw material limitations, and as a result, UV free radical-based inks became the dominant radiation-curable ink technology. At the same time, cationic UV coating technology, which had outstanding potential, had inherent compatibility issues with many conventional inks as well as UV free radical inks. Cationic UV inks could be “poisoned” by amines, which were common ingredients in UV inks as well as conventional inks. The less troublesome course was to use UV free radical coatings in combination with UV free radical inks. Early success of UV inks combined with UV coatings was based on free radical chemistry.

Although both technologies rely on high-energy UV radiation to cure the inks via a photoinitiator to start the rapid photo polymerization, this is about where the similarities end. Free radical UV inks and coatings depend on the generation of photo-induced decomposition of photoinitiators that produce fragments that contain an unpaired electron—a free radical. Such unpaired electron species are “hot” and chemically react rapidly with unsaturated monomers to produce free radical polymerization. Free radical polymerization can be inhibited by acids and proton-donors, but in general they are catalyzed by amines. Oxygen can scavenge the free radicals by forming peroxides that inhibit or delay the free radical curing process.

Cationic UV inks and coatings generate a photo-induced decomposition of a photoinitiator, which leaves a positively charged fragment, called a “cation”. This cation can take the form of an electron-deficient species such as a Lewis acid. Such electron-deficient or cationic intermediates are “hot” and chemically will react rapidly with epoxide monomers and similar chemicals to produce a cationic polymerization. Cationic polymerization is inhibited by amines and certain electron donor chemicals.

Differences between these technologies are that cationic UV systems typically produce systems with better adhesion as well as lower odor characteristics. The reasons for these differences lie in the inherent differences in the raw materials and the chemistry of the reactions. Whereas UV free radical chemistry brings unsaturated monomers together, and in doing so often will show film shrinkage, cationic UV systems open the epoxide strained ring, which expands or at least limits the shrinkage at the molecular level. In addition, when the polymerization is cationic, oxygen inhibition is not applicable, and unless there are some chemical inhibitors in the ink film, the cationic cure can proceed without inhibition.

Today, cationic UV systems are available in the form of inks, coatings, and adhesives. Their growth has been noteworthy in Europe, and applications have been commercialized in the use of UV cationic flexo inks as well as cationic UV-curable adhesives.

EP2042570A1 provides a photo-curable composition that addresses degradation in dispersibility caused by the use of a pigment, and has good color tone and high light fastness. The photo-curable composition includes: a polymerizable compound; a polymerization initiator, and a dye having two azo groups.

Nonetheless, while cationic UV-curable ink formulations (characterized by a cationic curing mechanism) are known and available for inkjet systems, their utility for printing on textile has been limited due to the problems associated with the brittleness of the final (fully cured) printed images: insufficient elongation properties (typically below 50%), poor flexibility and stiffness are typical to prints formed by cationic UV-curable formulations.

### SUMMARY OF THE INVENTION

The present disclosure provides a methodology and means for applying the methodology for digital inkjet printing of fabrics and other absorptive and flexible substrates, using cationic UV-curable ink compositions. The presently disclosed methodology solves the problem of brittleness and/or fastness of digitally printed images on fabrics using cationic UV-curable ink compositions, by adding a process step of applying an alkaline softener onto the freshly printed and UV-irradiated ink on the substrate, which is effected within a certain time interval, such that the initiation and polymerization is not impaired, yet the curing is affected such that the end result, after “dark curing” has essentially completed, the printed image has an acceptable hand feel.

Thus, according to an aspect of some embodiments of the present invention, there is provided a process for printing on a flexible and/or stretchable substrate. The process is carried out by:
loading the substrate onto a printing machine;
printing an image on a surface of the substrate using at least one cationic UV-curable ink composition;
exposing the surface to UV radiation (irradiating the image with UV light) to thereby initiating curing of the ink constituting the image; and
subsequent to the UV radiation step, depositing a softening composition on the image;
wherein the softening composition is deposited or digitally printed within a time interval of 1-600 seconds after the UV radiation step.

In some embodiments, the cationic UV-curable ink composition is formulated for inkjet printing systems.

In some embodiments, the softening composition is formulated for inkjet printing systems.

In some embodiments, the printing of the cationic UV-curable ink composition and the deposition of the softening composition are each effected in-line on the printing machine. In some embodiments, both the cationic UV-curable ink composition and the softening composition are printed on the substrate using an inkjet printhead, each a different one.

In some embodiments, the deposition of the softening composition is effected 60-120 seconds after the exposing.

In some embodiments, the deposition of the softening composition is effected 5-60 seconds after the exposing.

In some embodiments, the cationic UV-curable ink composition includes, inter-alia:
a pigment dispersion;
at least one epoxy resin;
at least one reactive diluent, and
at least one photoinitiator.

In some embodiments, the softening composition includes, inter-alia, a softening agent selected from the group consisting of a polysiloxane dispersion/emulsion, an amino-functional polysiloxane dispersion/emulsion, a cationic quaternary ammonium fatty acid condensation product dispersion/emulsion, and any combination thereof.

In another aspect there is provided a process for controlling the amount of curing of a printed image printed with a cationic UV-curable ink composition, the process comprising depositing a layer of a softening composition on said image subsequent to UV irradiating said image. The softening composition includes, inter-alia, a softening agent selected from the group consisting of a polysiloxane dispersion/emulsion, an amino-functional polysiloxane dispersion/emulsion, a cationic quaternary ammonium fatty acid condensation product dispersion/emulsion, and any combination thereof. The deposition of the softening layer subsequent to the image printing provides improved mechanical properties of the printed image, among others improved hand feel.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the phrases “substantially devoid of” and/or “essentially devoid of” in the context of a certain substance, refer to a composition that is totally devoid of this substance or includes less than about 5, 1, 0.5 or 0.1 percent of the substance by total weight or volume of the composition. Alternatively, the phrases “substantially devoid of” and/or “essentially devoid of” in the context of a process, a method, a property or a characteristic, refer to a process, a composition, a structure or an article that is totally devoid of a certain process/method step, or a certain property or a certain characteristic, or a process/method wherein the certain process/method step is effected at less than about 5, 1, 0.5 or 0.1 percent compared to a given standard process/method, or property or a characteristic characterized by less than about 5, 1, 0.5 or 0.1 percent of the property or characteristic, compared to a given standard.

When applied to an original property, or a desired property, or an afforded property of an object or a composition, the term “substantially maintaining”, as used herein, means that the property has not change by more than 20%, 10% or more than 5% in the processed object or composition.

The term “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The words “optionally” or “alternatively” are used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the terms “process” and “method” refer to manners, means, techniques and procedures for accomplishing a given task including, but not limited to, those manners, means, techniques and procedures either known to, or readily developed from known manners, means, techniques and procedures by practitioners of the chemical, material, mechanical, computational and digital arts.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

In addition, any priority document(s) of this application is/are hereby incorporated herein by reference in its/their entirety.

### DESCRIPTION OF EMBODIMENTS OF THE INVENTION

The present invention, in some embodiments thereof, relates to textile printing, and more particularly, but not exclusively, to cationic UV-curable digital ink compositions and methods for using the same.

Before explaining at least one embodiment of the invention in detail, it is to be understood that the invention is not necessarily limited in its application to the details set forth in the following description or exemplified by the Examples. The disclosure is meant to encompass other embodiments or of being practiced or carried out in various ways.

While conceiving the present invention, the present inventors envisioned a digital inkjet process for textile printing, which is based on UV-curable ink formulations activated by cationic curing mechanism, that would overcome the problems of insufficient elongation properties (typically below 50%), poor flexibility and stiffness that are typical in most of cationic UV-curable formulations. In addition, hand feel performance of the printed textile using cationic UV-curable ink might be challenging due to mentioned above. Hand feel is defined using following parameters, i.e. TS7, TS750 and D (measured by Tissue Softness Analyzer, or TSA).

While reducing the present invention to practice, the present inventors found out that once softener is introduced as an additive at the post printing process, hand feel parameters are significantly improved. Without being bound by any particular theory, it is assumed that in cationic polymerization the “dark curing” mechanism plays an important part in determining the resulting mechanical properties of the print. By “dark curing” it is meant that the polymerization process continue also after UV irradiation has stopped. It was also found that dark curing is important for overcoming other problems of polymerization stemming from the thickness of the ink layer and due to shadowed areas that are more frequent in textile.

In general, for most inkjet applications for textile, UV-curable inkjet inks should exhibit low viscosity to be jettable by printheads—typically up to 100 cPs at 20° C. and less than 20 cPs at 50° C. This requires usage of low molecular weight (due to low viscosity) reactive diluents that can be harmful for the customer when unpolymerized properly. Diluents and photoinitiators (or their photolysis products) could become leachable from cured ink film, and therefore may come in contact with skin via sweat causing allergic reactions and skin damage. Small leachable molecules (up to 500 Da) can easily penetrate the skin and cause toxic effects to the user. Reactive diluents and photoinitiators can be also volatile and cause allergic reaction in the respiratory tract. All stated above demands optimal ink formulation, its proper curing process are critical for textile printing application which is highly absorbent substrate.

### Objectives

One of the objectives of the present invention is the improvement of mechanical properties of cationic UV-curable ink compositions.

Wash and abrasion resistance are some of the basic requirements for printing on textile. The cationic UV-curable ink compositions provided herein exhibit low shrinkage, good adhesion, high crosslinking degree, which improves the resistance of the printed layer toward rub, wash and other forms of mechanical stress, yet afford a final result characterized by more than acceptable hand feel, stretchability and drape.

### Cationic Polymerizable Component

Cationic UV-curable ink compositions, according to some embodiments of the invention, contain one or more cationic polymerizable components, and optionally one or more non-cationic polymerizable components. The cationic polymerizable components may include functional groups such as epoxy, caprolactam, caprolactone, oxetane, vinyl ether, and the like. Non-limiting examples of epoxy-containing compounds include bis-(3,4 cyclohexylmethyl) adipate, 3,4-epoxy cyclohexylmethyl-3,4-epoxycyclohexyl carboxylate, 1,2 epoxy-4-vinylcyclohexane, 1,2-epoxy hexadecane and 3,4-epoxycyclohexylmethyl-3′,4′-epoxycyclohexane carboxylate, bis((3,4-epoxycyclohexyl)methyl) adipate. List of examples, under the trade names, include without limitation, Omnilane OC1005 from IGM Resins, TTA 26 from TETRA New Material Technology CO. LTD, CELLOXIDE 2081 from DAICEL Corporation, S128 from Lambson Fine Chemicals (England), and mono or multifunctional silicon epoxy resins such as CFS-328 which is available from Hubei Co-Formula Material Tech Co., LTD.

Definitions of specific functional groups, chemical terms, and general terms used throughout the specification are described in more detail below. For purposes of this invention, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999; Smith and March March's Advanced Organic Chemistry, 5^{th} Edition, John Wiley & Sons, Inc., New York, 2001; Larock, Comprehensive Organic Transformations, VCH Publishers, Inc., New York, 1989; Carruthers, Some Modern Methods of Organic Synthesis, 3^{rd} Edition, Cambridge University Press, Cambridge, 1987.

The cationic polymerizable compound(s) may be present in the ink composition in concentration that ranges from about 10 wt. % to about 95 wt. % of the total weight of the composition.

### Photoinitiator

Suitable cationic photoinitiators, according to some embodiments of the present invention, include compounds which form aprotic acids or Bronstead acids upon exposure to ultraviolet and/or visible light sufficient to initiate polymerization. The photoinitiator used may be a single compound, a mixture of two or more active compounds, or a combination of two or more different compounds, i.e. co-initiators.

Onium salts constitute a useful class of cationic photoinitiators. Triaryl Sulfonium (TAS) or diaryliodonium salts are representatives of this class of photoinitiators. Generally, the cationic initiator useful in the context of the present invention, may be any agent that is capable of initiating a cationic reaction when exposed to radiation at any suitable wavelength, including UV and visible light.

A non-limiting example of a suitable initiator is mixed arylsulfonium hexafluoroantimonate salts available under the trade name Speedcure 976 from Lambson (England). Other non-limiting examples of cationic initiators include iodonium, (4-methylphenyl) (4-(2-methylpropyl)phenyl)-hexafluorophosphate known as Irgacure 250 or Irgacure 270 available from Ciba Speciality Chemicals (Switzerland), mixed arylsulfonium hexafluoroantimonate salts known as Omnicat 320 available from IGM Resins, diaryliodonium hexafluoroantimonate known as PC 2506 available from Polyset Company (USA), (Tolylcumyl) iodonium tetrakis (pentafluorophenyl) borate known as Rhodorsil® Photoinitiator 2074 available from Bluestar Silicones (USA), iodonium bis(4-dodecylphenyl)-(OC-6-11)-hexafluoroantimonate known as TEGO PC 1466 from Evonik Industries AG (Germany).

The cationic photoinitiator may be present in the composition in a concentration that ranges from about 0.2 wt. % to about 7 wt. % based on the total weight of the composition. In some embodiments, the cationic initiator may be present in the composition from about 2 wt. % to about 4 wt. % by weight of the total first composition.

### Cationic Photosensitizers

The efficiency of the photopolymerization process depends on the overlap between the emission spectrum of the UV light source and the absorption spectrum of the photoinitiator. As the emission spectrum of normally used medium pressure mercury lamp does not necessarily optimally fit the excitation peak of iodonium salts, a sensitizer having an absorption spectrum different to that of the photoinitiator may be added to the composition. A variety of compounds can be used as photosensitizers in the presently provided cationic system, including, for example, heterocyclic and fused ring-aromatic hydrocarbons. Other non-limiting examples of cationic photosensitizers include dibutoxyanthrancene, phenothiazine, anthracene, curcumin and 2-isopropyl thioxanthonc.

### Pigment Dispersion

Pigment content of the ink can block penetration of UV light into deposited onto textile surface ink droplet causing poor photoinitiator activity and improperly polymerized ink film. This can be complicated further when ink is absorbed by fabric and additionally shadowed from UV light by fabric's fibers. Cationic “dark cure” mechanism can overcome these problems as it can continue the polymerization spatially to the depth of the ink layer and to shadowed areas.

Dispersion of pigments, suitable for use in the context of the present invention, are required to be reactive to UV-curing and include UV-reactive diluents in order to have fully cured ink. Non-limiting examples of dispersions are D3410-FX-B15:4, and UVD-J207 (Sun-Chemicals, U.S.).

### Toughening Agents

Epoxy resins which are polymerized in a cationic mechanism might be brittle and notch sensitive, particularly when the application is textile. Thus, according to some embodiments of the present invention, toughening agents may be added to the cationic UV-curable inkjet ink compositions provided herein.

In the context of the present invention, toughening is the ability of the polymer to absorb energy and plastically deform without fracturing. Toughness is related to elasticity and strength, and can be measured by calculating the area under the stress-strain curve. In order to be tough, a material must be both strong and ductile. For example, brittle materials (like ceramics) that are strong but with limited ductility are not tough; to be tough, a material should withstand both high stresses and high strains. Thus, brittle material needs more elongation to be tough. Toughening agents showed higher elongation (from 1-2% to 10-20%) while maintaining high tensile strength (about 10 MPa).

Adhesion enhancement of epoxy resins may be afforded in different ways including incorporation of an elastomeric dispersed phase and/or incorporation of components undergoing phase separation during curing. The toughening agent may be present in the second composition in a concentration from about 2% to about 20% based on the total weight of the second composition.

Non-limiting examples of a toughening agent include epoxidized polybutadiene (PB3600 (Daicel Corp., Japan)), Wax Wacker 350 (Wacker Chemie AG, Germany), which is polydimethylsiloxane-polycaprolactone-polydimethylsiloxane (ABA) triblock copolymer, Polyol R2490 and Polyol 3165 (Perstorp Holding AB).

### Softeners and Softening Composition

An acceptable, good hand feel, is one of the basic requirements posed by the consumer, particularly for textile pieces that are in close contact with customer's skin. The textile should be flexible and pleasant to wear and touch (garments, upholstery, home decor, etc.). Good mechanical properties present challenges especially for UV-curable inks as these typically contains 100% solids without any VOCs. Using cationic UV-curable ink compositions introduce an even more challenging feat due to the hard and brittle nature of the resulting polymers.

While high crosslinking levels, achieved with higher cycloaliphatic epoxy content, leads to reduced migration, it also leads to higher stiffness and poor hand feel. Treatment with softeners can eliminate this effect of stiffness and poor hand feel.

Non-limiting examples of softeners that can be used as a component in the UV-curable ink composition, according to some embodiments of the present invention, include RUCOFIN® SIQ NEW is a polymer modified internally quaternary silicone made by Rudolf Group, AVCO-ELASTOGUM® MAC-855 is a self-crosslinking aqueous mixture based on silicones made by AVCO Chemicals, AVCO-FINISH CORE is a concentrated hydrophilic polymer micro-emulsion stabilized by nonionic emulsifiers and made by AVCO Chemicals, AVCO-ELASTOGUM® MEC is a macro emulsion of amino-modified silicone made by AVCO Chemicals, and PERISOFT NANO and NANO/LM are hydrophilic silicone nano emulsions of quaternary polysiloxane polyalkylene oxide copolymers name by Textilchemie Dr. Petry GmbH.

Non-limiting examples of softening agents include polysiloxane dispersions/emulsions, amino-functional polysiloxane dispersions/emulsions, cationic quaternary ammonium fatty acid condensation product dispersions/emulsions, and any combination thereof.

The softening agents is typically dissolved in water at a concentration of 15-80 wt. % to afford the softening composition which is used in the process of printing the image, according to some embodiments of the present invention.

In some embodiments of the present invention, the softening composition is deposited on the UV-irradiated ink (the printed image) using inkjet machinery, and thus the softening composition is formulated to be suitable for inkjet printing systems. That means it is formulated for viscosity, particle size, conductivity and other parameters that are suitable for ejecting the composition from a digital inkjet printhead.

### Cationic UV-Curable Ink Composition

The cationic UV-curable ink composition provided herein includes non-toxic or low-toxicity chemicals using diluents at minimal amounts that are highly reactive to achieve fully cured ink which exhibits good hand feel and fastness. In addition, cationic UV-curable ink composition provided herein are formulated to exhibit “dark cure”, which is initiated by UV irradiation and continue to polymerize after the process (irradiation) has ceased, resulting in high degrees of curing and increased durability with low or null levels of leachables and extractables.

Thus, according to some embodiments of the present invention, there is provided a UV-curable digital ink composition, comprising:
a cationic polymerizable component;
Photoinitiator;
A stabilizer;
A surfactant or any other dispersing agent; and
A pigment dispersion.

Non-limiting examples of Cationic polymerizable component include bis-(3,4 cyclohexylmethyl) adipate, 3,4-epoxy cyclohexylmethyl-3,4-epoxycyclohexyl carboxylate, 1,2 epoxy-4-vinylcyclohexane, 1,2-epoxy hexadecane and 3,4-epoxycyclohexylmethyl-3′,4′-epoxycyclohexane carboxylate and bis((3,4-epoxycyclohexyl) methyl) adipate Non-limiting examples of Photoinitiator include iodonium, (4-methylphenyl) (4-(2-methylpropyl)phenyl)-hexafluorophosphate known, mixed arylsulfonium hexafluoroantimonate salts and iodonium bis(4-dodecylphenyl)-(OC-6-11)-hexafluoroantimonate

Non-limiting examples of pigment dispersion include D3410-FX-B15:4, and UVD-J207 (Sun-Chemicals, U.S.).

According to some embodiments of the present invention, the cationic UV-curable ink composition is formulated to be suitable for inkjet printing systems. That means it is formulated for viscosity, particle size, conductivity and other parameters that are suitable for ejecting the composition from a digital inkjet printhead.

### Process

While reducing the present invention to practice, it was found that the process of the deposition of the softener is crucial for the end result. The serendipitous finding was that when the softening agent is added to the ink, or when the softening composition is deposited concurrently with the ink, the curing process is harmed. Without being bound by any particular theory, it was proposed that the curing is adversely affected due to interactions between the basic (amine) softening agent and the acidic initiator, and as a result, the quality and fastness of printed image is impaired.

It was further found that if the softening agent is added after some time has lapsed, the curing is not harmed, and continues into the dark curing stage with no adverse effects, while the softening agent is incorporated into the cured ink, endowing it with the desired hand feel. In the context of the present invention, according to some embodiments of the present invention, a time interval is required to lapse between irradiating the printed ink on the substrate, and the depositing a softening composition on the partly-cured ink.

Since the softening composition is aqueous based, and the water had to be removed by heat, it was further found that this water-removal thermal treatment, conducted for the printed product, accelerates the curing process and can lead to complete cured ink in a much shorted time.

Hence, according to some embodiments of the present invention, there is provided a process for printing on a flexible and/or stretchable substrate, such as fabrics, which is carried out by:
loading the substrate onto a printing machine;
printing an image on a surface of the substrate using at least one cationic UV-curable ink composition, as provided herein;
exposing at least the printed surface to UV radiation to thereby initiate curing of the ink forming the image; and
subsequent to the UV irradiation step, depositing a softening composition on the partly cured image;
wherein the softening composition is deposited on the image within a time interval that ranges 1-600, 1-500, 1-400, 5-300, 5-200, 5-100, 5-50 seconds after UV irradiation of the image. In some embodiments, the softening composition is deposited on the image 100-150 seconds or 30-60 seconds after the UV irradiation.

In some embodiments of the present invention, the printing of the ink composition and the depositing of the softening composition are each effected in-line on the printing machine.

In some embodiments of the present invention, the effect of the alkaline (basic; amine-containing) softener on the initiation and progression of polymerization of cationic UV-curable ink compositions can be used for controlling the amount of curing of an image printed using a cationic UV-curable ink composition. The controllability is afforded by depositing the softening composition within a certain time interval after UV radiation of the printed ink; as discussed hereinabove, the amount of curing governs several parameters of the cured layer.

It is expected that during the life of a patent maturing from this application many relevant cationic UV-curable ink compositions will be developed and the scope of the phrase “cationic UV-curable ink compositions” is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions, illustrate some embodiments of the invention in a non-limiting fashion.

### Example 1

### Ink Composition

Formulations of general and specific ink compositions, according to some embodiments of the present invention, are presented in Table 1 below.

TABLE 1

| | | Ink | Ink |
|---|---|---|---|
| | | compo- | compo- |
| Component | | sition 1 | sition 2 |
| (Trade name) | Function | (w/w %) | (w/w %) |
| TTA21L | Epoxy resin | 45-60 | |
| DVE-3 | Reactive diluent | 5-10 | |
| Uvi-Cure S128 | Epoxy resin | | 27 |
| Curalite ™Ox | Reactive diluent | 15-30 | 41 |
| CFS-328 | Epoxy resin | | 15 |
| Polyol R2490 | Polyol | 5-15 | 13 |
| Omnicat 432 | Photoinitiator | 3-5 | |
| Omnicat 320 | Photoinitiator | | 4 |
| Total | | 100.00 | 100.00 |
| Viscosity (cPs; 50° C.) | | 17.7 | 13.7 |
| Surface tension (dyne/cm) | | 36.07 | 34 |

3,4-Epoxycyclohexylmethyl 3,4-Epoxycyclohexane Carboxylate (TTA21L) is a pale yellow to colorless liquid that is part of Cycloaliphatic Epoxy Resin TTA21 Series. It is a general-purpose cycloaliphatic diepoxide used principally with polyacid and anhydride cures. In particular, it provides good electrical loss properties, good weathering, and a high-heat-distortion temperature.

Triethyleneglycol divinyl ether (DVE-3) is a label-free, divinyl ether monomer with broad utility like coatings, inks and sealants. DVE-3 is a reactive diluent for unsaturated polyesters, UV coatings, UV inks, UV adhesives and release coatings. It is a crosslinker for Polyacrylate polymers used as ion exchange resins. It is a building block for sulfur-based sealant compounds. It performs low viscosity in UV-coatings, especially in cationic polymerization. It is used for UV-coatings (wood, printing inks), UV adhesives, and is suitable for cationic systems and also as a co-resin in free-radical systems.

Bis((3,4-epoxycyclohexyl)methyl) adipate (Uvi-Cure S128) is an adipate-based bifunctional cycloaliphatic epoxide resin which can be used alone or as an additive in some formulations to increase the flexibility of a cured coating. Uvi-Cure S128 is a standard cycloaliphatic epoxide resin, which contains an adipate chain that can make formulations of this product more flexible. When this product is combined with photoinitiators it can yield a clear, flexible, glossy coating in addition to combinations of flexibility and hardness. It is used in metal decoration coatings, overprint varnishes, white base coats, DVD adhesives, electrical coatings and sealants as well as flexo, screen and ink jet inks.

Curalite™ Ox is a cationic reactive diluent based on oxerane structure from Perstrop, low viscosity, odor-free, non-skin irritating, colorless liquid, which is one of the main components of UV/EB cationic formulations as a reactive diluent. It combines increased reactivity with good diluting power of epoxy resins and increases through cure and chemical resistance of the formulation. Curalite™ Ox is suitable for all types of cationic UV printing inks and overprint varnishes both for metal and plastic substrates.

CFS-328, known also as bis [2-(3,4-epoxycyclohexyl)ethyl]tetramethyldisiloxane (CAS 18724-32-8), is an epoxy resin.

Polyol R2490 is a bifunctional liquid polyol, used as a precursor for free radical radiation curing monomers and oligomers. This alkoxylated neopentyl glycol, having a secondary hydroxyl group, is also used as a chemical building block and as crosslinker in polyurethanes.

Omnicat 432 is a mixture of triarylsulfonium hexafluorophosphate salts and propylene carbonate, for cationic curing of epoxy, oxetane, and vinyl ether formulations.

Omnicat 320 is a colorless liquid photoinitiator of mixed triarylsulfonium hexafluoroantimonate salts in propylene carbonate. Omnicat 320 has been designed for the cationic curing of inks and coatings based on epoxy, oxetane, and vinyl ether formulations. Omnicat 320 exhibits high cure-speed, low odor, and excellent post (dark) curing.

### Example 2

### Softening Composition

Formulations of a softening compositions, according to some embodiments of the present invention, are presented in Table 2 below.

TABLE 2

| | | Softening | Softening |
|---|---|---|---|
| Component | | composition1 | composition2 |
| (Trade name) | Function | (w/w %) | (w/w %) |
| EG MEC | Softening agent | 50-70 | |
| Amino-silicone | | | |
| Finish core | Softening agent | | 60-80 |
| Amino-silicone | | | |
| Deionized Water | Carrier | 30-50 | |
| PG, Glycol | Humectant | | 20-40 |
| Total | | 100.00 | 100.00 |
| Viscosity@ | | 14.8 | 10-13 |
| 50° C. (cPs) | | | |
| Surface tension | | 22.8 | 27-30 |
| (dyne/cm) | | | |

### Example 3

### Printing Process

The printing process is designed to achieve optimal results in terms of the quality of the printed image, namely in terms of efficiency, wash and rub fastness, and hand feel.

In the proof of concept presented herein, the process was carried out on an experimental printing system, the parameters of which are presented in Table 3 below.

TABLE 3

| Machine parameter | Details | |
|---|---|---|
| Printer model | Avalanche by Kornit | |
| Frequency | 14-20 | kHz |
| Jetting Temperature (0 C.) | 50-55 | |
| UV irradiation source | 2 Mercury Medium Pressure lamps | |
| Dosage (UVA + UVB)* | ~2 | J/cm² |

| | |
|---|---|
| Resolution | 8 × 6 |
| Printing heads | PQW15pL |

The UV lamps (Mercury 100 W, Subzero 055_085 of Integration technology) are located from both sides of the printed heads allowing immediate cure following jetting. Curing can be performed using LED, but formulation should be adjusted in terms of PIs mainly. The ink jetting is performed directly on the fabric w/o pretreatment.

Process includes depositing of highly pigmented cationic ink. The deposited layer is exposed immediately to UV illumination which initiate curing.

Deposition of softener on top of partially cured UV-curable ink is followed by IR drying or hot air drying. Softener can be applied by inkjet printheads or by spray.

### Example 4

### Results

Softness was determined using a Tissue Softness Analyzer (TSA), available from EMTEC Electronic GmbH of Leipzig, Germany. Briefly, the TSA comprises a rotor with vertical blades which rotate on the test piece to apply a defined contact pressure. Contact between the vertical blades and the test piece creates vibrations, which are sensed by a vibration sensor. The sensor then transmits a signal to a PC for processing and display. The frequency analysis in the range of approximately 200 to 1000 Hz represents the surface smoothness or texture of the test piece and is referred to as the TS750 value. A further peak in the frequency range between 6 and 7 kHz represents the bulk softness of the test piece and is referred to as the TS7 value. Both TS7 and TS750 values are expressed as dB V2 rms.

The stiffness of the sample is also calculated as the TSA device measures deformation of the sample under a defined load. The stiffness value (D) is expressed as mm/N. The device also calculates a Hand Feel (HF) number with the value corresponding to softness as perceived when someone touches a tissue sample by hand (the higher the HF number, the higher the softness). The HF number is a combination of the TS750, TS7, and stiffness of the sample measured by the TSA and calculated using an algorithm, which also requires the caliper and basis weight of the sample. Different algorithms can be selected for different facial, toilet, and towel paper products. Before testing, a calibration check should be performed using “TSA Leaflet Collection No. 9” available from EMTECH dated 2016 May 10. If the calibration check demonstrates a calibration is necessary, “TSA Leaflet Collection No. 10” is followed for the calibration procedure available from EMTECH dated 2015 Sep. 9.

Cationic ink has continuous “dark cure” which is initiated by UV radiation but polymerization continues without UV irradiation (hence “dark curing”) which leads to high degrees of curing and increased stiffness which results poor hand feel (Table 4). This can also be accompanied by thermal treatment, e.g., by IR irradiation, which accelerates the polymerization and can lead to complete cured ink. Table 4 presents the TS7 test results.

TABLE 4

| Post Cure | TS7* |
|---|---|
| 1 hour at RT | 31.354 |
| 5 hours at RT | 33.804 |
| 5 days at RT | 36.587 |
| IR irradiation | 37.965 |

In order to improve current hand feel of the printed ink, softener formulation was jetted over the printed ink as part of the printing process, and the softener was based on silicone-amine. Since cationic chemistry suffers from inhibition effect by bases as amines, thioles and etc., softener should be jetted once UV ink is cured and not prior curing.

The process steps were tested comparatively using Ink composition 1 (see Table 1), and the results are presented in Table 5 below.

TABLE 5

| Process | UV | Softener | | | TS7 |
|---|---|---|---|---|---|
| # | radiation | deposition | RT* | IR | results |
| 1 | 2 | | 3 | | 35.863 |
| 2 | 2 | | | | 31.864 |
| 3 | 2 | 4 | 3 | 5 | 31.0 |
| 4 | 2 | 4 | 5 | 3.6 | 30.5 |
| 5 | 2 | 4 | | 3.5 | 23.8 |
| 6 | 2 | 3 | | 4 | 19.4 |

*1 week at RT

Since cationic ink undergoes post cure at room temperature which leads to increase in TS7, softener needs to be deposited immediately after UV-curing of the ink. This phenomenon can be observed in the processes presented in Table 5.

As can be seen in Table 5, in the processes where post cure at RT was allowed before applying softener (process #3, and #4) one can see a slight improvement in hand feel from TS7-35 without softener (process #1) to 30-31. In processes without RT post cure (process #5, and #6) one can see improved hand feel results (23 and 19) compared to the process without softener and post cure (process #2).

That means the best process which will give us the good hand feel we need in the product must be printing softener immediately after curing printed ink by UV, without any post cure process between them (nor RT post cure neither IR).

Without being bound by any particular theory, it is assumed that introducing a softener into the polymerization reaction by depositing a softening composition on the partly-cured ink less than the time period required after the UV exposition of the cationic ink, according to some embodiments of the present invention, the “dark curing” process is inhibited and the polymerization process of the cationic ink is stopped or at least partly impaired, resulting with a less hard film due to less crosslinking in the film.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A process for printing on a flexible and/or stretchable substrate, comprising:
loading the substrate onto a printing machine;
printing an image on a surface of the substrate using at least one cationic UV-curable ink composition;
exposing said surface to UV radiation to thereby initiating curing of said image; and
subsequent to said exposing, depositing a softening composition on said image;
wherein said depositing is effected within a time interval of 1-600 seconds after said exposing.

2. The process of claim 1, wherein said cationic UV-curable ink composition is formulated to be suitable for inkjet printing systems.

3. The process of claim 1, wherein said softening composition is formulated to be suitable for inkjet printing systems.

4. The process of claim 1, wherein said printing and said depositing are each effected in-line on said printing machine.

5. The process of claim 1, wherein said depositing is effected 60-120 seconds after said exposing.

6. The process of claim 1, wherein said depositing is effected 5-60 seconds after said exposing.

7. The process of claim 1, wherein said cationic UV-curable ink composition comprises:
a pigment dispersion;
at least one epoxy resin;
at least one reactive diluent, and
at least one photoinitiator.

8. The process of claim 1, wherein said softening composition comprise a softening agent selected from the group consisting of a polysiloxane dispersion/emulsion, an amino-functional polysiloxane dispersion/emulsion, a cationic quaternary ammonium fatty acid condensation product dispersion/emulsion, and any combination thereof.
